(19) United States
(12) Patent Application Publication
(10) Pub. No.: US 2026/0070142 A1
(43) Pub. Date: Mar. 12, 2026

(54) Orbital Welding Device with Welding Head Being Adjustable Between an Open and a Closed State

(71) Applicant: Viega Technology GmbH & Co. KG, Attendorn (DE)

(72) Inventor: Daniel Knupfer, Zizers (CH)

(21) Appl. No.: 19/251,119

(22) Filed: Jun. 26, 2025

(30) Foreign Application Priority Data
Jun. 28, 2024 (DE) 10 2024 118 372.1

(51) Int. Cl. B23K 9/028; B23K 37/02

(52) U.S. Cl. CPC B23K 9/0286; B23K 37/0247

(57) ABSTRACT

The invention relates to an orbital welding device with a welding head that has a receptacle for positioning a joining area of two joining partners, in particular a fitting and a pipe end, in which joining partners are tubular at least in the joining area. The welding head has a first opening and a second opening opposite the first opening, between which the receptacle extends, and wherein the welding head is adjustable between an open position and a closed position. The welding head, in the open position, has an insertion opening connecting the first and second openings for inserting a joining area of two joining partners, which are tubular at least in the joining area, into the receptacle, and wherein the insertion opening is at least partially closed in the closed position. The invention further relates to a system with such an orbital welding device and an orbital welding method.

### CROSS-REFERENCE TO RELATED APPLICATION

This application claims priority to German Patent Application No. 10 2024 118 372.1 filed Jun. 28, 2024, the disclosure of which is hereby incorporated by reference in its entirety.

### BACKGROUND OF THE INVENTION

### Field of the Invention

The present invention relates to an orbital welding device with a welding head that has a receptacle for positioning a joining area of two joining partners, in particular a fitting and a pipe end, which joining partners are tubular at least in the joining area. The present invention further relates to a system with such an orbital welding device and an orbital welding method.

### Description of Related Art

In the prior art, arc-based orbital welding methods, in particular tungsten inert gas welding methods (TIG welding methods), are used, for example, for the material-locking connection of pipes. In this process, the pipe ends to be joined are arranged next to each other, typically in a butt joint, and welded together by moving the welding tool in the circumferential direction of the pipes (orbitally) around the joint. The welding torch can be guided manually or automatically.

On the outside of the pipes, tarnishing can be largely suppressed by the shielding gas used in TIG welding, although oxidation may still occur after the welding process due to residual heat in the workpiece. Additional measures are required to protect the inner surface of the pipes from oxidation, such as flushing the pipes with forming gas.

Orbital welding of copper pipes has proven to be particularly difficult in this respect. Due to the good thermal conductivity of copper, the heat introduced into the material from the outside during the welding process is quickly dissipated, requiring higher amounts of energy to reach the necessary temperatures at the weld site. This is accompanied by higher energy requirements, which makes the use of battery-powered welding equipment difficult. In addition, the high thermal conductivity of copper causes the inner surface of the pipe to heat up significantly, making it particularly susceptible to tarnishing and oxidation on the inside of the pipe.

It has been found that the orbital welding process can be optimized in such a way that, even when welding copper, there is less heating of the inner surface of the pipe and thus less susceptibility to tarnishing and oxidation on the inside of the pipe. It has been found that, for such process optimization, it is particularly advantageous to align the electrode and the joining partners as precisely as possible and to guide the electrode as precisely as possible during the welding process. However, the known orbital welding devices are in need of improvement in terms of precision and/or are quite large or complex, so that they are not particularly suitable for orbital welding devices designed as hand-held devices.

Against this background, the present invention has the object of providing an orbital welding device, a system with such an orbital welding device, and an orbital welding method with which at least some of the aforementioned problems can be reduced or avoided.

### SUMMARY OF THE INVENTION

The aforementioned object is solved according to the invention by an orbital welding device comprising a welding head having a receptacle for positioning a joining area of two joining partners, in particular a fitting and a pipe end, which joining partners are tubular at least in the joining area, wherein the welding head has a first opening and a second opening opposite the first opening, between which openings the receptacle extends, wherein the welding head is adjustable between an open position and a closed position, wherein the welding head, in the open position, has an insertion opening connecting the first and second openings for inserting a joining area of two joining partners, which are tubular at least in the joining area, into the receptacle, and wherein the insertion opening is at least partially closed in the closed position.

Such an adjustable welding head makes it easier for the operator, in the open position, to position the orbital welding device on the joining partners to be joined or to arrange the joining area of the joining partners in the receptacle. Furthermore, the closed position allows better enclosure of the receptacle, so that the joining partners can be fixed more securely in the receptacle and the actual orbital welding process can be better shielded from the outside.

The receptacle extends between the first and second openings, particularly in the longitudinal direction. In this way, two joining partners to be arranged with the joining area in the receptacle, in particular a fitting and a pipe end, can extend out of the first and second openings.

The receptacle of the welding head of the orbital welding device is for positioning a joining area of two joining partners that are tubular at least in the joining area. Both joining partners each have a joining area in which the joining partners are to be welded together. In the case of a push-on fitting, the joining area of the fitting may, for example, comprise an area at the fitting opening, and the joining area of a pipe end to be welded thereto may comprise the area of the pipe end which is located at the fitting opening when the fitting is pushed on. In the case of an insertion fitting, the joining area of the fitting may, for example, comprise an area at a stop edge for a pipe end, and the joining area of a pipe end to be welded to it may comprise the area of the pipe opening which abuts against the stop edge when the fitting is inserted. The joining area of the fitting and the joining area of the pipe end, or more generally the respective joining areas of the two joining partners, together form the joining area of the two joining partners.

In addition to the two joining partners, further joining partners may also be provided.

The welding head surrounds the receptacle, in particular at least in sections in the azimuth direction.

The insertion opening forms an azimuthal insertion area. In this way, in the open position, the two joining partners can be inserted with the joining area into the receptacle through the insertion opening, i.e., the welding head can in particular be placed onto the joining partners, in particular a pipe end and a fitting, from the side, especially if these are already arranged relative to each other, for example, inserted into each other. In the closed position, the two joining partners may be fixed in particular with the joining area in the receptacle. Preferably, the insertion opening is completely closed in the closed position. In this way, better protection of the user against UV or welding fume exposure is achieved. Furthermore, the escape of protective gas can be largely avoided.

The orbital welding device preferably comprises an adjustment mechanism and a closure actuator for actuating the adjustment mechanism, wherein the adjustment mechanism is configured to adjust the welding head between the open position and the closed position. The closure actuator is preferably mechanically operable. The adjustment mechanism may in particular comprise one or more closure ring segments, preferably driven in opposite directions.

The aforementioned object is further solved according to the invention by means of a system comprising the orbital welding device described above or an embodiment thereof and a fitting. The fitting is in particular designed to be used together with the orbital welding device to produce a material-locking connection between the fitting and a joining partner, in particular a pipe end, by means of orbital welding. For this purpose, the fitting is preferably adapted to the geometry of the orbital welding device. In particular, the fitting and the welding head of the orbital welding device may have corresponding contours, such as an outer contour of the fitting and a corresponding fitting fixing contour of the welding head, in order to position the fitting in a predetermined fitting position in the welding head. The fitting position is preferably such that the joining area of the fitting, for example an edge of the fitting at which the fitting is to be welded to the pipe end, is located in the area of a preferably provided electrode ring segment or in the area of the welding electrode, in particular at a predetermined distance, for example less than 1.5 mm, in particular less than 1.2 mm, between the tip of the welding electrode and the edge of the fitting. In addition or alternatively, the welding head and the fitting may be designed to hold the fitting in the specified fitting position by means of a force-fit. For this purpose, a fixing element made of an elastomer may be arranged in the welding head, for example, which fixing element forms a fixing surface against which the fitting is pressed in the closed position of the welding head.

The fitting may in particular comprise a fitting body made of metal, for example copper or a copper alloy. In particular, the fitting body may form the outer contour of the fitting.

The aforementioned object is further solved according to the invention by an orbital welding method carried out with an orbital welding device, in particular with the orbital welding device described above or an embodiment thereof, in which two joining partners, which are tubular at least in a joining area, are arranged relative to each other, in particular in a lapped joint, and in which a chain of joining spots (welding spots) extending in the circumferential direction of the joining partners is produced in the joining area, which chain connects the joining partners in a material-locking manner.

In one embodiment of the method, the joining area of the joining partners is introduced into the receptacle through the insertion opening when the welding head is in the open position, and the joining partners are fixed in the receptacle by adjusting the welding head to the closed position before the chain of joining spots is produced. In this way, a predetermined alignment of the joining area relative to the welding electrode can be ensured during the creation of the chain of joining spots, thereby increasing the welding quality.

Various embodiments of the orbital welding device, the system, and the orbital welding method are described below, whereby the individual embodiments apply independently of each other to the orbital welding device, the system, and the orbital welding method. In addition, the individual embodiments can be combined with each other as desired.

In one embodiment, the welding head has one or more closure ring segments, each of which having a respective ring segment opening in the circumferential direction and being arranged in the circumferential direction around the receptacle and being mounted in such a way that the respective closure ring segment is rotatable about an imaginary longitudinal axis of the receptacle. It is further preferred that, in the open position, each of the one or more closure ring segments is positioned in an open rotational position in which the respective ring segment opening forms part of the insertion opening, and, in the closed position, is positioned in a closed rotational position in which the respective closure ring segment at least partially closes the insertion opening. This mechanism allows the welding head to be adjusted between the open and closed positions in a simple, reliable, and, in particular, space-saving manner. This allows the welding head to be designed compactly, which is particularly advantageous in difficult assembly situations and when the welding head is part of a hand-held device.

If the welding head comprises a plurality of closure ring segments, the closure ring segments may in particular be rotatable about the same imaginary longitudinal axis of the receptacle. It is also conceivable that the closure ring segments are rotatable about a respective imaginary longitudinal axis of the receptacle, wherein the imaginary longitudinal axes of different closure ring segments may be offset relative to one another. For example, one or more upper closure ring segments may be rotatable about a first imaginary longitudinal axis of the receptacle, and one or more lower closure ring segments may be rotatable about a second imaginary longitudinal axis of the receptacle, which second imaginary longitudinal axis preferably runs at a distance parallel to the first imaginary longitudinal axis.

The one or more imaginary longitudinal axes of the receptacle run in particular through the receptacle.

The one or more closure ring segments may also serve in particular to fix the joining partners arranged in the receptacle and, for this purpose, preferably each have an inner contour facing the receptacle, for example as part of a fitting fixing contour, for bearing against one of the joining partners.

In one embodiment, the welding head has a plurality of closure ring segments, and the direction of rotation from the open rotational position to the closed rotational position of at least two of the plurality of closure ring segments, in particular of two closure ring segments arranged next to each other in the longitudinal direction, is opposite. In this way, the ends of these closure ring segments at the respective ring segment openings move toward each other during adjustment from the open to the closed rotational position. This allows for a more compact design, since the individual closure ring segments only have to move over part of the insertion opening, for example only to about the middle of the insertion opening, in order to close the insertion opening. Furthermore, such a counter-rotating movement enables a symmetrical fixation and, in particular, centering of the joining partners in the receptacle.

In one embodiment, one or more first ones of the one or more closure ring segments are arranged in the region of the first opening and/or one or more second ones of the one or more closure ring segments are arranged in the region of the second opening. This achieves symmetrical closure of the insertion opening with respect to the longitudinal axis of the receptacle. Preferably, both joining partners may be fixed by the closure ring segments in this way.

It is further preferred that a first closure ring segment with a first direction of rotation and a further closure ring segment with a direction of rotation opposite thereto are respectively arranged in the region of the first opening and/or second opening. In this way, symmetrical fixing of the joining partners on both sides at the first and/or second opening is possible.

Preferably, the one or more first closure ring segments in the region of the first opening and/or the one or more second closure ring segments in the region of the second opening are designed to clamp a joining partner, in particular a fitting or pipe end, resting against them. For this purpose, the one or more closure ring segments may, for example, be spring-loaded. The closure ring segments may then bear against the corresponding joining partner with a clamping force and thus clamp it. In this way, good electrical contact between the closure ring segments and the respective joining partner can be ensured. By clamping the respective joining partner, a force-fit fixation in the circumferential direction may also be achieved.

In one embodiment, one or more upper ones of the one or more closure ring segments are connected in a rotationally fixed manner to an upper cover and/or one or more lower ones of the one or more closure ring segments are connected in a rotationally fixed manner to a lower cover, wherein the upper and/or lower cover clears the insertion opening in the open position of the welding head and at least partially close the insertion opening in the closed position of the welding head. In this way, the insertion opening may substantially be closed in such a way that, in the closed position of the welding head, the receptacle in the region of the welding electrode is preferably substantially completely closed in the circumferential direction. In this way, the orbital welding process can be carried out in a substantially closed space and thus under controlled conditions. Furthermore, the protective gas used in the orbital welding process can be retained in the joining area.

Furthermore, the environment can be protected from fumes and UV radiation generated during the orbital welding process.

In one embodiment, one, several, or each of the closure ring segments is coupled to a gear, in particular a toothed gear, by means of which the respective closure ring segment can be adjusted between the open rotational position and the closed rotational position. By coupling several or all of the closure ring segments to the gear, synchronous adjustment of the closure ring segments can be achieved. For coupling with the gear, the closure ring segments may preferably each have a toothing, in particular in the form of a toothed rim segment, which meshes with the gear. The gear may in particular have one or more gear wheels.

In one embodiment, an actuating element is provided with which the one or more closure ring segments can be adjusted between the open rotational position and the closed rotational position. In particular, the closure ring segments may be coupled to the actuating element via the gear described above. The actuating element is preferably manually operable. In this way, the closure ring segments can be adjusted synchronously between the open and closed rotational positions by actuating the actuating element. The actuating element may also be electrically driven, in particular by a motor. In this way, the actuating element can be actuated automatically, for example after a user input via a user interface, for example after pressing a corresponding button.

The actuating element may, for example, be designed in the form of a rotatable handle sleeve which may be arranged, for example, on a shaft, in particular of a hand-held device, the shaft extending transversely to the longitudinal extension of the receptacle. The axis of rotation of the handle sleeve is preferably transverse to the imaginary axis of rotation of the one or more closure ring segments. This allows the user to operate the actuating element easily and ergonomically.

The actuating element may in particular comprise a crown wheel coupled to one or more gear wheels of the gear described above. In this way, the rotational movement can be redirected from the axis of rotation of the actuating element to the axis of rotation of the one or more closure ring segments in a space-saving manner. Preferably, a first and a second gear wheel are provided, wherein the first and second gear wheels mesh with the crown wheel on opposite sides of the crown wheel, wherein the first gear wheel is coupled to one or more closure ring segments arranged in the region of the first opening and the second gear wheel is coupled to one or more closure ring segments arranged in the region of the second opening. This allows the closure ring segments arranged in the region of the first and second openings to be adjusted synchronously with the actuating element in a space-saving manner.

The first and/or second gear wheel is preferably connected in a rotationally fixed manner to a further, in particular smaller, gear wheel which is coupled to one of the closure ring segments via an intermediate gear wheel. The intermediate gear wheel achieves a reversal of the direction of rotation, so that two closure ring segments arranged next to each other and moving in opposite directions can be adjusted in a space-saving manner.

The actuating element may for example also be designed in the form of a lever which drives the one or more closure ring segments, for example via one or more gear wheels.

In one embodiment, the orbital welding device comprises a hand-held device which comprises the welding head and preferably a handle connected to the welding head. Preferably, a welding current source and a control unit may also be accommodated in the hand-held device. In addition, the hand-held device may have a battery or a rechargeable battery, a receptacle or a connection therefor, in particular for an exchangeable rechargeable battery. For example, a connection for plugging in an exchangeable rechargeable battery may be provided. In this way, flexible and simple operation of the orbital welding device is also possible under cramped working conditions.

Preferably, the orbital welding device is designed entirely as a hand-held device, in particular with an integrated or pluggable rechargeable battery, in particular an exchangeable rechargeable battery. This allows particularly flexible and easy use of the orbital welding device.

It is also conceivable that the orbital welding device comprises, in addition to the hand-held device, at least one case or backpack connected to the hand-held device, for example by means of a hose package, in which case or backpack components of the orbital welding device, such as the welding current source and/or a battery or rechargeable battery or a receptacle therefor, are arranged. In this way, the hand-held device can be made more compact and lighter, which makes it easier to operate. At the same time, the orbital welding device remains mobile.

In one embodiment, the orbital welding device comprises an electrode circulation mechanism and an electrode drive, in particular a motor, for driving the electrode circulation mechanism, wherein the electrode circulation mechanism is configured to move a welding electrode or an electrode holder therefor in the circumferential direction around the receptacle. In this way, during the orbital welding process, the welding electrode can be moved automatically and in a controlled manner in the circumferential direction around the joining area of the joining partners, which are arranged in the receptacle, in order to weld them together, in particular by means of a chain of joining spots.

In one embodiment, the welding head has an electrode ring segment which is arranged in the circumferential direction around the receptacle and is mounted in such a way that the electrode ring segment can be rotated about an imaginary longitudinal axis of the receptacle, wherein the electrode ring segment has an electrode holder for a welding electrode and/or a welding electrode, and wherein the welding head has a plurality of driven drive wheels which are arranged such that, in each rotational position of the electrode ring segment about the imaginary longitudinal axis, at least one of the plurality of drive wheels is coupled to the electrode ring segment. In this way, a welding electrode can be moved precisely in the circumferential direction around the joining area of two tubular joining partners. In particular, the described mechanism enables such precise electrode guidance that the welding process can be carried out with very small and precisely maintained distances between the welding electrode tip and one or both of the joining partners, which enables better optimization of the welding process in order to reduce the energy requirement and the heating of the inner surface of a pipe end to be joined and thus the susceptibility to tarnishing and oxidation on the inner side of the pipe.

The electrode ring segment and the drive wheels may in particular form the electrode circulation mechanism of the orbital welding device or part thereof.

In one embodiment, the orbital welding device comprises a welding current source which is electrically connected to the electrode ring segment, the welding electrode and/or the electrode holder therefor. Furthermore, the welding current source is preferably connected to one or more contacting elements for contacting a joining partner arranged in the receptacle. In this way, a voltage can be applied between the welding electrode and the joining partner during operation using the welding current source. The welding current source is preferably configured to provide an ignition voltage for contactless ignition of an arc between the welding electrode and the joining partner. Furthermore, the welding current source is preferably configured to provide a welding current for the orbital welding process, in particular to control the welding current according to a predetermined or predeterminable welding current characteristic curve.

In one embodiment of the orbital welding device, a control unit is provided which is configured to control the orbital welding device in such a way that, by means of a or the welding electrode, a weld seam consisting of a circumferential chain of joining spots is produced on two joining partners arranged in the receptacle. For this purpose, the control unit preferably comprises at least one processor and at least one memory with commands whose execution on the at least one processor causes corresponding control of the orbital welding device. The memory may be, for example, a ROM memory or a RAM memory. In particular, the control unit of the orbital welding device may control the welding current source and/or the electrode drive.

In one embodiment of the orbital welding device, a welding head position sensor system is provided for detecting the open and/or closed position of the welding head. The welding head position sensor system may, for example, be configured to detect the position of one or more of the one or more closure ring segments. For this purpose, the welding head position sensor system may, for example, be configured to detect a position of the one or more closure ring segments on the one or more closure ring segments themselves or on the gear, for example a gear wheel, for driving them. The control unit is preferably configured to control the orbital welding device as a function of measured values from the welding head position sensor, for example to only allow a welding process to start when the welding head position sensor detects that the welding head is in the closed position.

### BRIEF DESCRIPTION OF THE DRAWINGS

Further features and advantages of the orbital welding device, the system, and the orbital welding method emerge from the following description of embodiments, with reference being made to the accompanying drawing.

In the drawing

FIG. 1 shows a first exemplary embodiment of the orbital welding device,

FIG. 2a-d show the welding head of the orbital welding device from FIG. 1,

FIG. 3 shows a schematic block diagram of the functional components of the orbital welding device from FIG. 1,

FIG. 4 shows a schematic block diagram of the welding current source of the orbital welding device from FIG. 1,

FIG. 5a-b show a schematic representation of the creation of a joining spot in the orbital welding process,

FIG. 6a-c show an exemplary embodiment of the orbital welding method on a fitting and a pipe end,

FIG. 7 shows another exemplary embodiment of the orbital welding device, and

FIG. 8a-i show detailed views of the welding head of the orbital welding device from FIG. 1 or 7.

### DESCRIPTION OF THE INVENTION

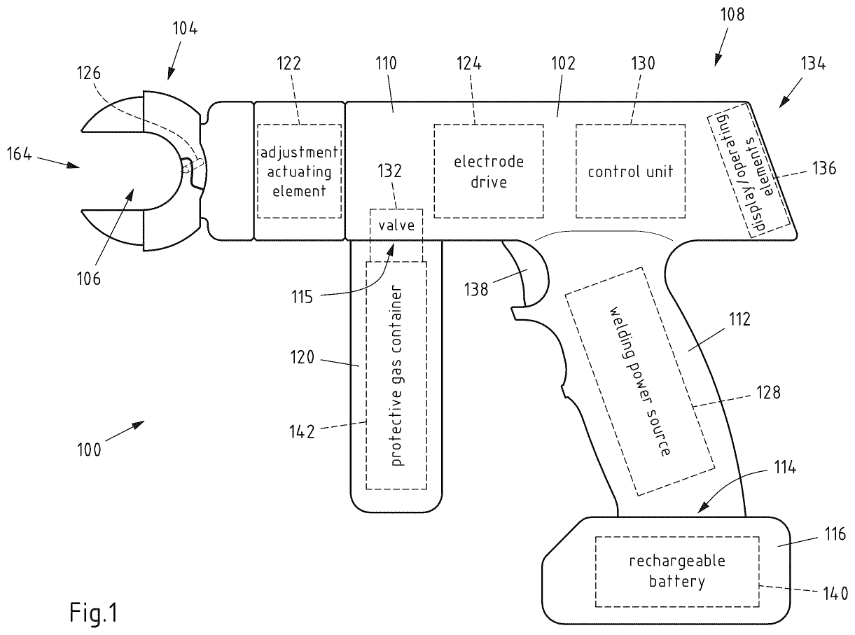

FIG. 1 shows an exemplary embodiment of the orbital welding device in schematic representation.

The orbital welding device 100 is designed as a mobile welding device in the form of a hand-held device 102. In the present exemplary embodiment, the hand-held device 102 comprises all components of the orbital welding device 100, so that the orbital welding device 100 can be handled very flexibly, even in difficult installation situations.

First, the hand-held device 102 comprises a welding head 104, which has a receptacle 106 in which a joining area of two joining partners, for example a pipe end and a fitting, can be arranged.

The hand-held device 102 further comprises a handle part 108 with a shaft 110 on which the welding head 104 is arranged, and with a handle 112 for holding and operating the hand-held device 102. The handle 112 has a connection 114 for an exchangeable rechargeable battery unit 116 at its end opposite the shaft 110. The shaft 110 further has a connection 115 for an exchangeable protective gas magazine 120.

The handle part 108 houses various components for operating the orbital welding device 100, namely in particular an adjustment actuating element 122 for adjusting the welding head 104 between an open and a closed position, an electrode drive 124 for driving a welding electrode 126 in the welding head 104, a welding current source 128 for supplying the ignition voltage and the welding current for the orbital welding process, a control unit 130 for controlling the orbital welding device 100, a valve 132 for controlling the protective gas supply, and a user interface 134 comprising display and operating elements 136 for configuring the orbital welding device 100 and a trigger 138 for starting an orbital welding process. Furthermore, the rechargeable battery unit 116 comprises a rechargeable battery 140, for example a lithium-ion rechargeable battery, and the protective gas magazine 120 comprises a protective gas container 142.

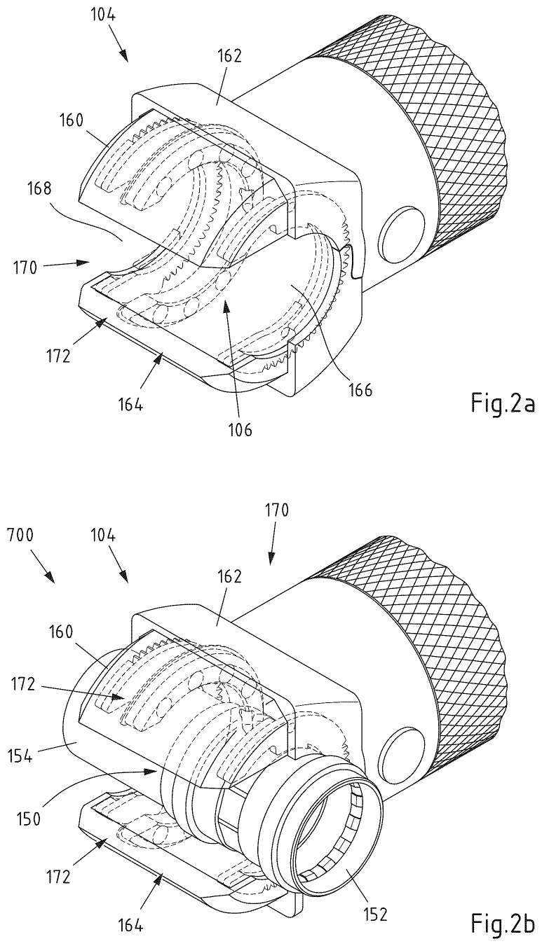

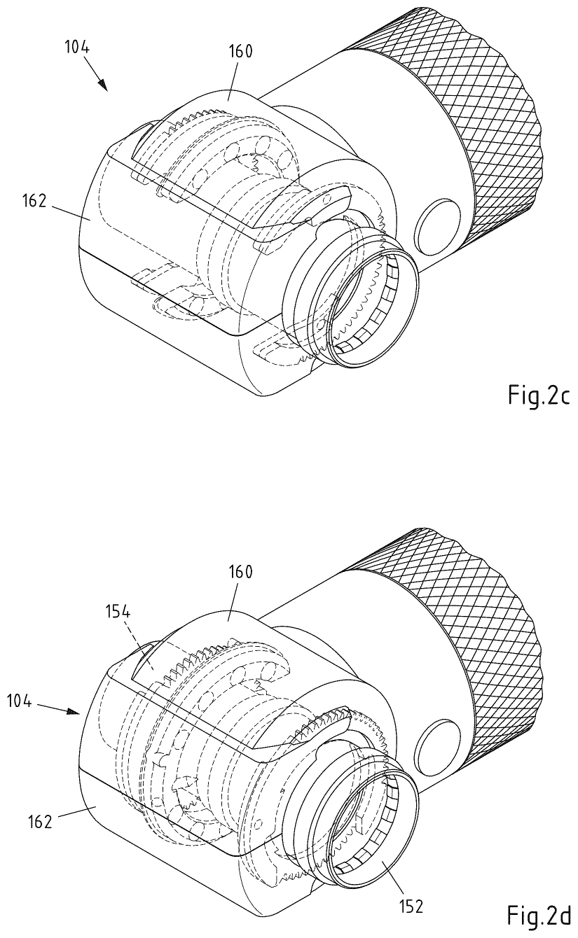

FIGS. 2a-d show the welding head 104 of the orbital welding device 100 in a schematic, perspective view, namely in the open position (FIG. 2a), in the open position after a joining area 150 of two joining partners, namely a fitting 152 and a pipe end 154, has been arranged in the receptacle 106 (FIG. 2b), and in the closed position before (FIG. 2c) and during the execution of an orbital welding process (FIG. 2d).

The welding head 104 has a fixed part 160, which surrounds the receptacle 106 in sections in the circumferential direction, and a movable part 162. In the open position, the movable part 162 is at least partially retracted into the fixed part 160 and exposes an insertion opening 164 in the circumferential direction. In the closed position, the movable part 162 closes the insertion opening 164 so that the receptacle 106 is essentially completely closed in the circumferential direction. In axial direction (longitudinal direction), the receptacle 106 extends between a first opening 166 and a second opening 168.

An adjustment mechanism 170 is provided on the welding head 104 for adjusting the welding head 104 between the open and closed positions. Furthermore, an electrode circulation mechanism 172 is provided on the welding head 104, with which, in the closed position of the welding head 104, the welding electrode 126 can be moved in the circumferential direction around the receptacle 106 for carrying out an orbital welding process.

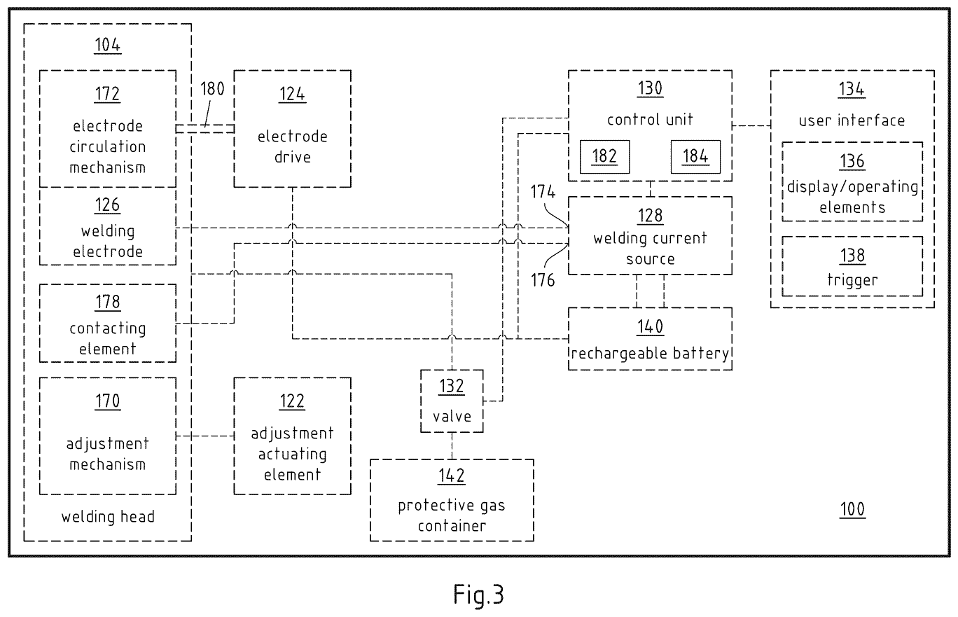

FIG. 3 shows a schematic block diagram of the functional components of the orbital welding device 100 from FIG. 1. The rechargeable battery 140 supplies all electrical components of the orbital welding device 100 with electrical energy. In particular, the rechargeable battery 140 supplies the welding current source 128, the control unit 130, and the electrode drive 124.

The welding current source 128 provides the ignition voltage for arc ignition and the welding current for the orbital welding process. For this purpose, the welding current source 128 has two outputs 174, 176, one of which, during an orbital welding process, is electrically conductively connected to the welding electrode 126 and the other of which is electrically conductively connected to one or more contacting elements 178 for contacting a joining partner arranged in the receptacle 106.

The electrode drive 124 preferably comprises an electric motor and is connected, for example via an axle 180, to the electrode circulation mechanism 172 in order to transmit the movement, for example rotary motion, from the electric motor to the electrode circulation mechanism 172 so that the electrode circulation mechanism 172 moves the welding electrode around the receptacle 106.

The control unit 130 is configured to control the orbital welding device 100 and, for this purpose, may in particular comprise at least one microprocessor 182 and a memory 184 with commands whose execution on the at least one microprocessor 182 causes controlling of the orbital welding device 100.

Furthermore, the control unit 130 is connected to the user interface 134 in order to output user outputs, for example via a screen comprised by the display and operating elements 136, and to receive user inputs, for example via buttons or a touchscreen comprised by the display and operating elements 136 or from the trigger 138.

The control unit 130 is in particular configured for controlling an orbital welding process. For this purpose, the control unit 130 is connected in particular to the electrode drive 124, to the valve 132 for controlling the protective gas flow to the welding head 104, and to the welding current source 128 for controlling them.

In the present exemplary embodiment, the adjustment actuating element 122 is designed in a mechanical manner so that a user can drive the adjustment mechanism 170 by manually actuating the adjustment actuating element 122 in order to adjust the welding head 104 between the closed and open position. However, it is also conceivable that the adjustment actuating element 122 is motorized, for example, has an electric motor that can be controlled via the control unit 130, so that the welding head 104 can be automatically adjusted between the closed and open position.

The protective gas container 142, which contains a protective gas, in particular an inert gas, and is preferably exchangeable, is connected to the welding head 104 via the valve 132, wherein the welding head 104 preferably has a protective gas duct for bringing the protective gas for the orbital welding process into the region of the welding electrode 126.

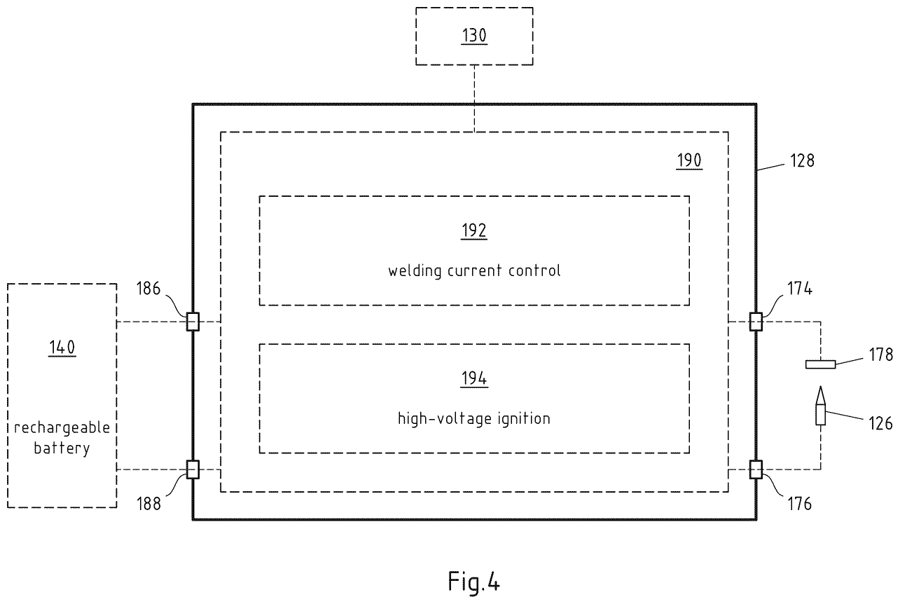

FIG. 4 shows a schematic block diagram of the functional components and connections of the welding current source 128. The welding current source 128 has two inputs 186, 188 for connecting the two poles of the rechargeable battery 140 and the two outputs 174, 176 for supplying the ignition voltage and the welding current and for electrically conductive connection to the contacting element 178 and the welding electrode 126.

The welding current source 128 has an electronic circuit 190 which is supplied by the voltage, in particular direct voltage, applied to the inputs 186, 188 and can supply an ignition voltage for igniting an arc and a welding current for feeding an arc welding process via the outputs 174, 176. The electronic circuit 190 may, for example, comprise one or more electronic switches, in particular a half-bridge circuit, and preferably at least one coil.

The electronic circuit 190 may further comprise its own control unit, for example a microprocessor, which controls the operation of the welding current source 128, in particular by controlling one or more switches of the electronic circuit 190.

The electronic circuit 190 is functionally configured to provide a high-voltage pulse at the outputs 174, 176 for igniting the welding arc. This is illustrated in FIG. 4 by the functional module HV ignition 194. Furthermore, the electronic circuit 190 is configured to effect a welding current control with which the amperage of a welding current flowing via the outputs 174, 176, i.e. the welding current amperage, can be controlled, in particular in accordance with a predetermined current characteristic curve. This is illustrated in FIG. 4 by the functional module welding current control 192.

Accordingly, the control unit of the welding current source 128 may in particular be configured to cause generation of a high-voltage pulse for igniting a welding arc and then supply of a welding current for an orbital welding process, in particular to cause a welding current control. The control unit of the welding current source 128 is preferably configured to control the welding current according to a predetermined or predeterminable welding current characteristic curve when the arc is burning.

The welding current source 128 is connectable to or connected to the control unit 130 and can thus be controlled by the control unit 130. In particular, the control unit 130 may control the control unit of the welding current source 128 in order to initiate and/or configure the control of the operation of the welding current source 128 by the control unit of the welding current source 128.

Instead of two separate control units, it is also conceivable that the control unit 130 and the control unit of the welding current source 128 are designed as a common control unit, for example as one microprocessor.

In the following, the execution of an orbital welding process with the orbital welding device 100 is described, namely the execution of an orbital welding process on a pipe end 154 and a fitting 152.

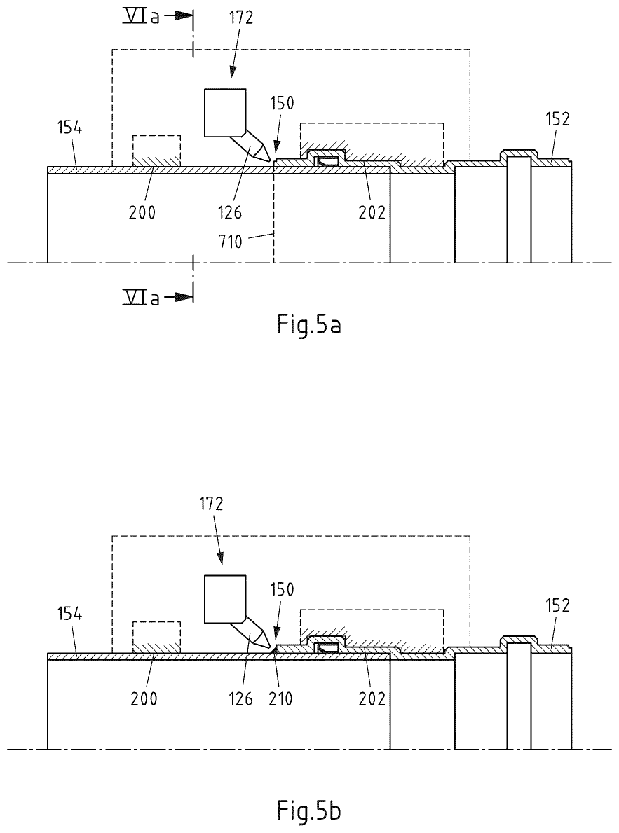

FIGS. 5a-b each show a schematic cross-sectional view of the joining area 150 of fitting 152 and pipe end 154 arranged in the welding head 104, wherein the figures show only an upper half. The shown components of the welding head 104 are partially shown in dashed lines.

The fitting 152 is pushed onto the pipe end 154, as shown in FIG. 5a. For this purpose, the inner cross-section of the fitting 152 is preferably adapted to the outer cross-section of the pipe end 154 in such a way that only a small gap remains between the outer wall of the pipe end 154 and the inner wall of the fitting 152.

The lapped joint formed in this way between pipe end 154 and fitting 152 forms the joining area 150 in which fitting 152 and pipe end 154 are to be welded together.

In order to carry out the orbital welding process, the welding head 104 is first adjusted to the open position via the adjustment actuating element 122 so that the movable part 162 of the welding head 104 clears the insertion opening 164 (FIG. 2a). The hand-held device 102 with the welding head 104 can then be placed on the joining area 150 of the pipe end 154 and the fitting 152 pushed onto it with the insertion opening 164 from the side, so that the joining area 150 is located in the receptacle 106 (FIG. 2b), while the remaining part of the fitting 152 and the remaining part of the pipe end 154 extend out of the receptacle 106 through the openings 166, 168.

The welding head 104 is then adjusted to the closed position by means of the adjustment actuating element 122 (FIG. 2c). In the closed position, the joining area 150 of pipe end 154 and fitting 152 is preferably fixed in the receptacle 106 in a form-fitting and/or force-fitting manner by the fixed part 160 and the movable part 162 of the welding head 104, in particular fixed in the axial direction and, more preferably, also in the azimuth direction. Furthermore, this fixing preferably also causes alignment of pipe end 154 and fitting 152, particularly preferably centering of pipe end 154 in fitting 152.

In FIG. 5a, the contours 200, 202 fixing the fitting 152 and the pipe end 154 are shown schematically with dashed lines. The fixing is carried out in particular in such a way that the joining area 150 is located in the area of the welding electrode 126. The welding electrode 126 is directed obliquely inwards, in particular at an angle to the radial direction in the range 5-45°, for example 45°, and may be directed obliquely in the circumferential direction, i.e. in the welding direction, for example at an angle in the range 0-15° to the radial direction. The welding electrode 126 points with its tip toward the lapped joint in the arrangement shown in FIG. 5a. The contours 200, 202 may, in particular, belong at least partially to the one or more contacting elements 178 in order to connect fitting 152 and pipe end 154 in an electrically conductive manner to an output of the welding current source 128.

The contours 200 are in particular adapted to the outer contour of the fitting. The contours 200, 202 fixing the fitting 152 and pipe end 154 may in particular be designed to brace the fitting 152 and the pipe end 154, in particular to hold them in a force-fitting manner. Such fixing of the fitting 152 and/or pipe end 154 enables reliable electrical contact of the fitting 152 or the pipe end 154 to be achieved.

The orbital welding device 100 with the welding head 104 and the fitting 152 form a system 700.

In the closed position of the welding head 104, the joining area 150 is preferably completely enclosed in the circumferential direction so that the protective gas supplied during the orbital welding process is retained in the joining area 150 and the environment, in particular the user, is protected from welding fumes and UV light generated during the orbital welding process.

After the welding head 104 has been adjusted to the closed position, the user can trigger the start of the orbital welding process, for example by pressing the torch trigger 138. The control unit 130 controls the electrode drive 124 and the welding current source 128 in such a way that the welding electrode 126 produces a chain 211 of joining spots 210 in the circumferential direction, which connect the fitting 152 and the pipe end 154 in a material-locking manner.

FIGS. 5a-b schematically show the creation of a joining spot 210. To create a first joining spot 210, the welding current source 128 first generates a high-voltage pulse, which causes a contactless ignition of an arc between the welding electrode 126 and the fitting 152 or pipe end 154. The welding current source 128 then controls the welding current in accordance with a welding current characteristic curve, which comprises in particular a sequence of high-current phases and low-current phases. During the high-current phases, the heat input caused by the arc leads to the formation of a molten pool (also referred to as a weld pool) at the lapped joint of fitting 152 and pipe end 154, which solidifies at least partially during the low-current phase and forms a joining spot 210. To ensure that the next joining spot is created offset in the circumferential direction from the previous joining spot, the control unit 130 controls the electrode drive 124 so that it moves the welding electrode 126 further in the circumferential direction, and the welding current source 128 causes a new molten pool to be melted in the next high-current phase for the adjacent joining spot, which preferably overlaps with the first joining spot. A new ignition is not necessary for the second and subsequent joining spots, since the arc preferably burns continuously until the last joining spot.

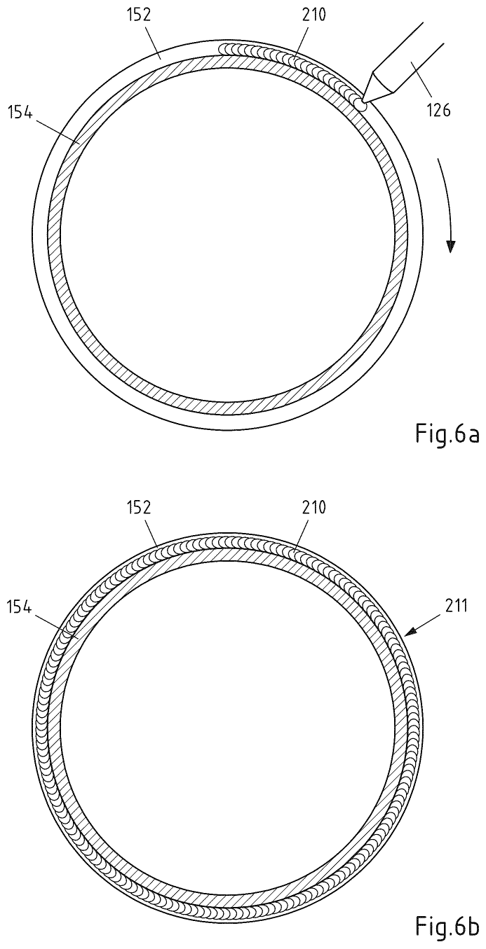

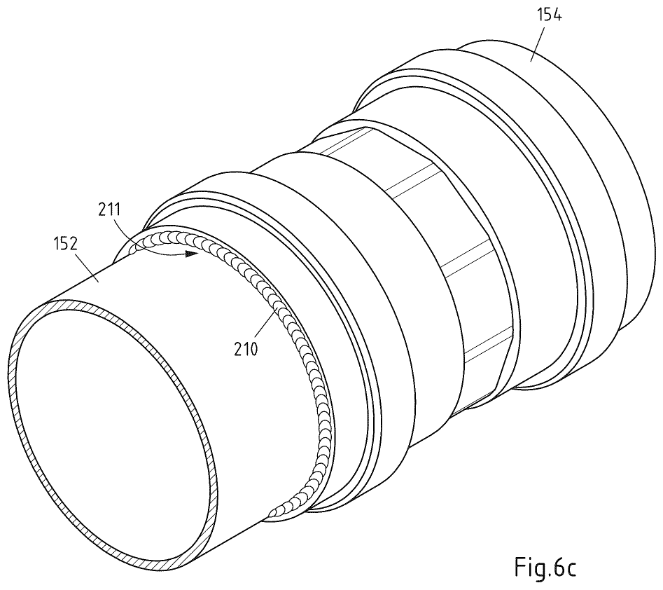

In this way, the chain 211 of joining spots 210 is gradually created, through which the fitting 152 and pipe end 154 are preferably connected to each other in a fluid-tight manner at the lapped joint. FIGS. 6a-b show the creation of the joining spots 210 in schematic cross-sectional views corresponding to the cutting plane designated “Vla” in FIG. 5a, wherein FIG. 6a shows a point in time during the ongoing orbital welding process and FIG. 6b shows a point in time after completion of the orbital welding process. FIG. 6c shows a perspective view of the finished joint seam (weld seam) of fitting 152 and pipe end 154.

After the finished joint seam has been produced, the welding current source 128 reduces the welding current to zero so that the arc is extinguished. By actuating the adjustment actuating element 122, the welding head 104 can then be adjusted back into the open position by the user, and the welding head 104 can be removed laterally from the now materially bonded fitting 152 and pipe end 154.

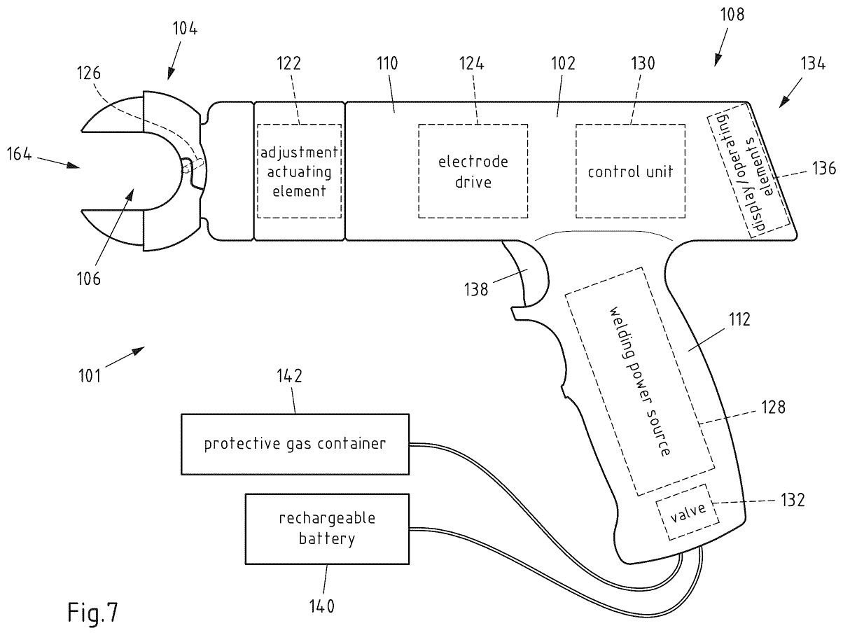

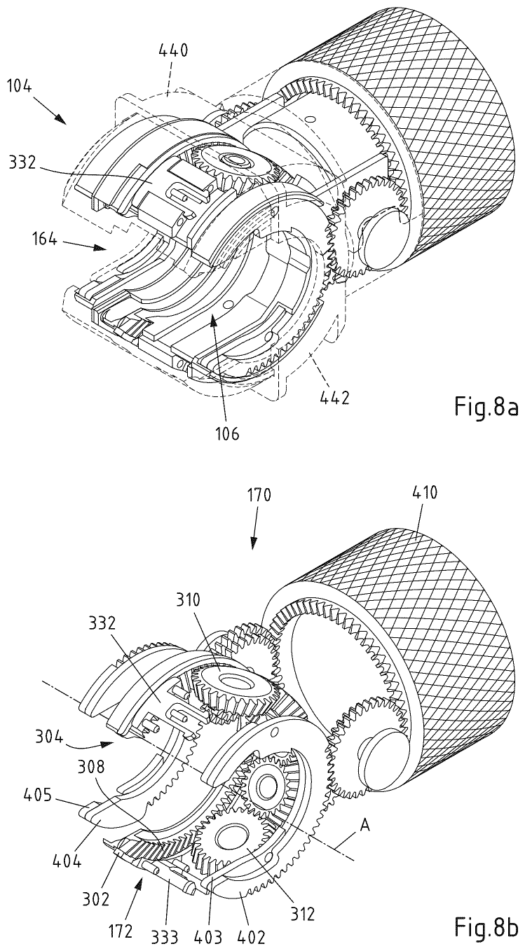

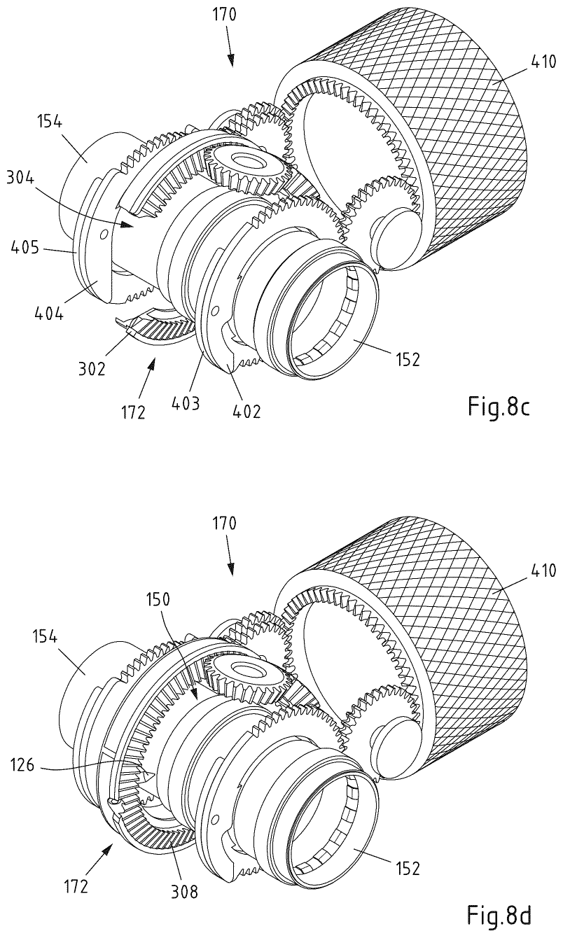

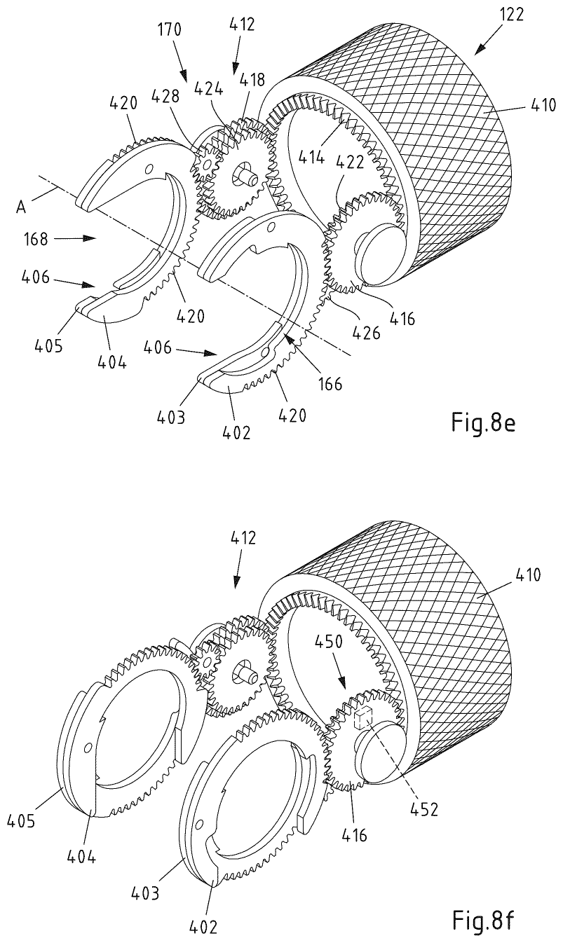

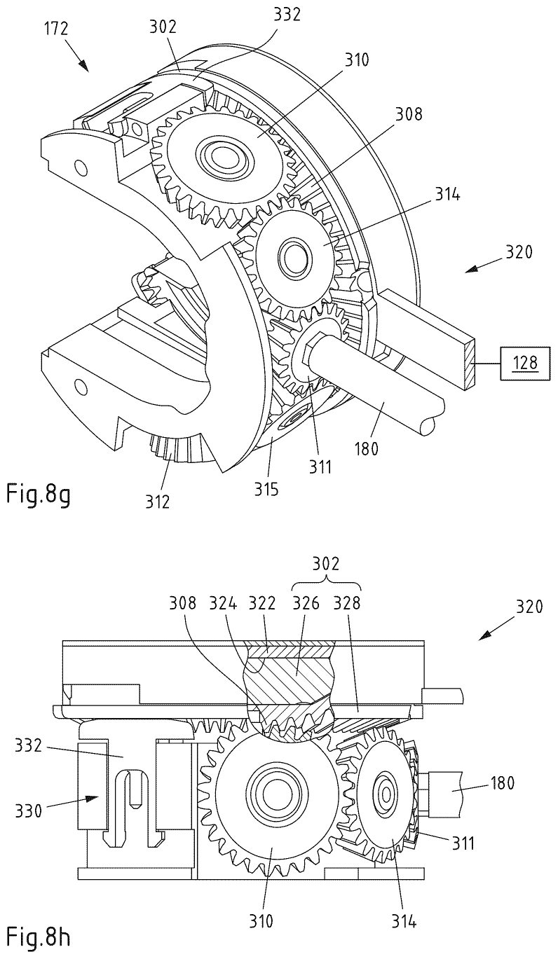

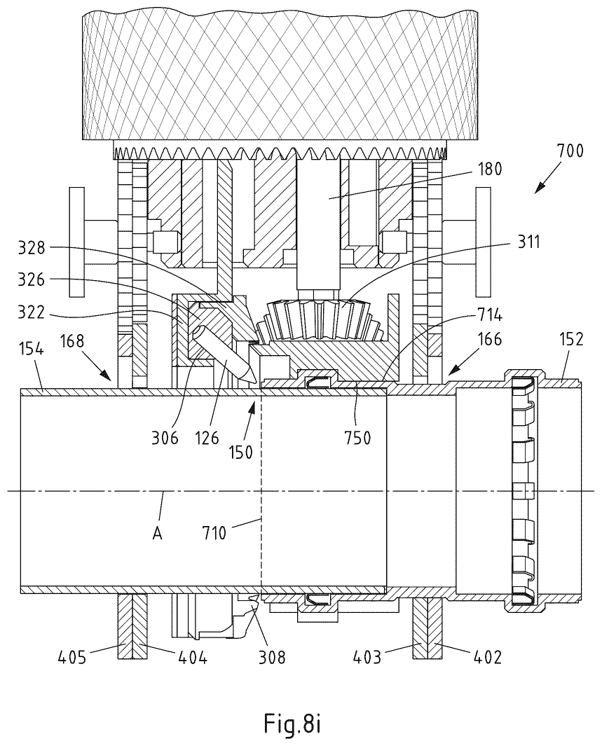

FIG. 7 shows a further exemplary embodiment of the orbital welding device. The orbital welding device 101 has a similar structure and mode of operation to the orbital welding device 100. Functionally corresponding components are therefore assigned the same reference symbols, even if they may be arranged or designed differently in some respects, and reference is made to the above description of FIGS. 1-6c and the following description of FIGS. 8a-i.

The orbital welding device 101 differs from the orbital welding device 100 in that some components, in FIG. 7 the protective gas container 142 and the rechargeable battery 140, are designed separately from the hand-held device and are connected to it by corresponding gas or power lines. In this way, the hand-held device can be made more compact and lighter. Furthermore, larger protective gas containers 142 and rechargeable batteries 140 can be used in this way. The protective gas container 142 and the rechargeable battery 140 may, for example, be arranged in a separate case or backpack.

Instead of a rechargeable battery, a mains connection for supplying power to the hand-held device 102 of the welding current source 128 may also be provided. This allows longer operation, albeit with more limited flexibility in handling.

FIGS. 8a-i show more detailed views of the welding head 104 of the orbital welding device 100 from FIG. 1 and of the orbital welding device 101 from FIG. 7, respectively. FIG. 8a shows the welding head 104 in perspective view, with the outer components being shown partially transparent with dashed lines. FIGS. 8b-d show the electrode circulation mechanism 172 and the adjustment mechanism 170 in perspective view, in the open (FIG. 8b) and closed position of the welding head (FIGS. 8c-d) and in the initial position (FIGS. 8b-c) and rotated position of the electrode circulation mechanism 172 (FIG. 8d). In FIGS. 8c-d, the joining area 150 of fitting 152 and pipe end 154 is also inserted into the receptacle 106. FIGS. 8e-f show a perspective view of the adjustment mechanism 170 in the open (FIG. 8e) and closed position of the welding head 104 (FIG. 8f). FIGS. 8g-h show the electrode circulation mechanism 172 and the contacting means 320 in perspective view (FIG. 8g) and in view from above (FIG. 8h). FIG. 8i shows the welding head 104 with the joining area 150 of fitting 152 and pipe end 154 arranged in the receptacle 106 in sectional view.

The welding head 104 comprises the receptacle 106 for positioning a joining area 150 of two joining partners, which are tubular at least in the joining area 150, namely a fitting 152 and a pipe end 154.

The electrode circulation mechanism 172 of the welding head 104 comprises a C-shaped electrode ring segment 302, which is arranged in the circumferential direction around the receptacle 106 and is mounted in the welding head 104 in such a way that it can rotate endlessly around an imaginary longitudinal axis A of the receptacle 106, i.e. through any angle. The electrode ring segment 302 has a ring segment opening 304 in the circumferential direction, the size of which is adapted to the insertion opening 164 and which, in the open position (see FIGS. 8a-b), is arranged such that it forms part of the insertion opening 164.

The electrode ring segment 302 has an electrode holder 306 for the welding electrode 126, which can be inserted into the electrode holder 306 or is inserted therein. When the welding electrode 126 is worn, it can be removed from the electrode holder 306 and a new welding electrode can be inserted.

The electrode ring segment 302 is designed as a bevel gear wheel segment and accordingly has a bevel gear wheel toothing 308 on one side. The electrode circulation mechanism 172 further comprises several, in this case two, drive wheels 310, 312 arranged in the circumferential direction around the receptacle in the form of drive bevel gear wheels, which engage with the bevel gear wheel toothing 308 of the electrode ring segment 302. The drive bevel gear wheels 310, 312 are arranged such that, in every rotational position of the electrode ring segment 302, at least one of the drive bevel gear wheels 310, 312 is in engagement with the bevel gear wheel toothing 308 of the electrode ring segment 302. The drive bevel gear wheels 310, 312 are coupled to the electrode drive 124 via an axle 180 by means of a coupling bevel gear wheel 311 and further coupling bevel gear wheels 314, 315 arranged between the coupling bevel gear wheel 311 and the drive bevel gear wheels 310, 312. The axes of rotation of the drive bevel gear wheels 310, 312 and coupling bevel gear wheels 311, 314, 315 lie in a plane transverse to the longitudinal axis A. This ensures synchronous and uniform movement of the drive bevel gear wheels 310, 312.

Furthermore, contacting means 320 are provided for electrical contacting of the electrode ring segment 302 and the welding electrode 126 and for electrical connection to the welding current source 128.

The contacting means 320 comprise a contacting ring segment 322 which is arranged offset in the axial direction next to the electrode ring segment 302 and is electrically conductively connected or connectable to the welding current source 128. The contacting ring segment 322 is preferably completely conductive on the side 324 facing the electrode ring segment 302 or has one or more conductive sections on the side 324.

The electrode ring segment 302 is also electrically conductive on the side facing the contact ring segment 322. In the present exemplary embodiment, the electrode ring segment 302 is designed in multiple parts and has a conductive ring segment 326 made of conductive material, for example copper, on the side facing the contact ring segment 322, and a drive ring segment 328 on the side facing the drive bevel gear wheels 310, 312 which drive ring segment carries the bevel gear wheel toothing 308. The drive ring segment 328 is preferably made of insulating material, for example plastic. The electrode holder 306 is formed by the conductor ring segment 326 or is electrically conductively connected thereto.

In order to ensure large-area contact between the conductor ring segment 326 and the contact ring segment 322 during rotation of the electrode ring segment 302 for transmission of the welding current with as little loss and interruption as possible, pressing means 330 in the form of a plurality of spring-mounted pressing elements 332, 333 are provided in the welding head 104, which pressing means press the electrode ring segment 302 against the conductor ring segment 326 and thus press these two components against each other. The pressing elements 332, 333 are distributed in the circumferential direction so that at least one of the pressing elements 332, 333 is in contact with the electrode ring segment 302 in every rotational position of the electrode ring segment 302.

The welding head 104 further has several C-shaped closure ring segments 402, 403, 404, 405, each of which being arranged in the circumferential direction around the receptacle 106 and being mounted in the welding head 104 in such a way that it can rotate about the longitudinal axis A of the receptacle.

The closure ring segments 402, 403, 404, 405 are each arranged in pairs next to each other, namely two closure ring segments 402, 403 in the region of the first opening 166 and two closure ring segments 404, 405 in the region of the second opening 168.

The closure ring segments 402, 403, 404, 405 each have a ring segment opening 406 in the circumferential direction, the size of which is adapted to the insertion opening 164.

The closure ring segments 402-405 can each be adjusted between an open rotational position (see FIG. 8e) and a closed rotational position (see FIG. 8f), whereby the direction of rotation from the open rotational position to the closed rotational position of the closure ring segments 402 and 403 as well as, respectively, 404 and 405 arranged directly next to each other is opposite in each case.

In order to adjust the closure ring segments 402-405 from the open rotational position to the closed rotational position, the orbital welding device 100 has an actuating element 410 in the form of a handle sleeve. The actuating element 410 is coupled to the closure ring segments 402-405 via a gear 412, so that by rotating the actuating element 410, the closure ring segments 402-405 can be adjusted synchronously from the open rotational position to the closed rotational position or from the closed rotational position to the open rotational position.

The gear 412 comprises a crown wheel 414 provided on the actuating element 410, which on the side of the closure ring segments 402, 403 and on the side of the closure ring segments 404, 405 respectively meshes with a gear wheel 416, 418, the respective axes of rotation of which being transverse to the axis of rotation of the actuating element 410. The gear wheel 416 is in turn coupled to the closure ring segments 402, 403 and the gear wheel 418 is coupled to the closure ring segments 404, 405. For this purpose, the closure ring segments 402-405 have respective outer toothing 420, whereby the gear wheels 416, 418 are coupled directly to the outer toothing 420 of the respective outer closure ring segment 402, 405 and to the outer toothing 420 of the respective inner closure ring segments 403, 404 via a smaller gear wheel 422 or 424 connected coaxially and rotationally fixed to the respective gear wheel 416, 418 and an intermediate gear wheel 426 or 428 arranged therebetween for changing the direction of rotation. The transmission ratio from gear wheel 416 to the outer toothing 420 of closure ring segment 402 is equal to the transmission ratio from gear wheel 424 to the outer toothing 420 of closure ring segment 404. Furthermore, the transmission ratio from gear wheel 422 to the external teeth 420 of the closure ring segment 403 is equal to the transmission ratio from gear wheel 418 to the external teeth 420 of the closure ring segment 405. Furthermore, the transmission ratio from gear wheel 416 to the external teeth 420 of closure ring segment 402 is equal to the transmission ratio from gear wheel 422 to the external teeth 420 of closure ring segment 403.

In this way, the rotary movement of the actuating element 410 can be transmitted synchronously to all four closure ring segments 402-405 with different directions of rotation. The use of the crown wheel 414 allows, in particular, a particularly compact redirection of the rotary movement. Furthermore, the use of the rotationally fixed gear wheels 422, 424 with the intermediate gear wheels 426, 428 allows a particularly compact reversal of the direction of rotation for the respective adjacent closure ring segments 402, 403 and 404, 405, respectively.

In the open position (see FIG. 8a, b & e), the closure ring segments 402-405 are positioned in their respective open rotational positions, in which the respective ring segment opening 406 of the closure ring segments 402-405 is positioned in such a way that it forms part of the insertion opening 164.

In the closed position (see FIG. 8c, d, f & i), the closure ring segments 402-405 are positioned in their respective closed rotational positions, in which the closure ring segments 402-405 are each positioned such that they partially close the insertion opening 164.

In order to close the insertion opening 164 as completely as possible in the closed position, the welding head 104 has an upper cover 440 and a lower cover 442, which are each connected in a rotationally fixed manner to two closure ring segments 402 and 405 (upper closure ring segments) and 403 and 404 (lower closure ring segments), respectively, such that the covers 440, 442 clears the insertion opening 164 in the open position of the welding head 104 and close it in the closed position of the welding head 104.

The actuating element 410 constitutes the adjustment actuating element 122 of the orbital welding device 100; and the closure ring segments 402-405 with the gear 412 constitute the adjustment mechanism 170 of the orbital welding device 100.

A welding head position sensor system 450 may be provided to detect whether the welding head 104 is in the closed position. For this purpose, a sensor 452 may be arranged on the gear wheel 416, for example, with which the rotational movement of the gear wheel 416 can be detected and the position of the closure ring segments 402-405 can thus be determined. For example, one or more magnets may be integrated into the gear wheel 416, the passage of which in one direction or the other being detected by the sensor 452, thereby detecting the rotational movement of the gear wheel 416.

The welding head position sensor system 450 can be used in particular to determine whether the welding head 104 is in the closed position. The control unit 130 can, for example, be designed to only carry out a welding process when the welding head 104 is in the closed position.

FIG. 8i shows the welding head 104 with the joining area 150 of the pipe end 154 and the pushed-on fitting 152 arranged in the receptacle 106 in sectional view. The fitting 152 has an outer contour 714 and the welding head 104 has a corresponding fitting fixing contour 750 in order to fix the fitting 152 in a predetermined fitting position when the welding head 104 is in the closed position, so that the fitting opening 710 assumes a predetermined position relative to the welding electrode 126, in particular a predetermined distance from the tip of the welding electrode 126. The fitting fixing contour 750 corresponds to the contour 202 schematically indicated in FIG. 5a. Preferably, the welding electrode 126 maintains the specified distance or distance range from the fitting opening 710 in every rotational position of the welding electrode 126, so that the orbital welding process can be carried out with a very small distance between the welding electrode 126 and the fitting opening 710.

The closure ring segments 402-405 are preferably designed to clamp the fitting 152 and the pipe end 154 in the specified position. For this purpose, the sealing ring segments 402-405 may, for example, be designed to be slightly springy, for example by forming the sealing ring segments 402-405 themselves from a springy material and/or by mounting the sealing ring segments 402-405 in a springy manner. In this way, reliable electrical contact between fitting 152 and pipe end 154 is also achieved by the closure ring segments 402-405.

The orbital welding device 100 with the welding head 104 and the fitting 152 with the outer contour 714 adapted to the fitting fixing contour 750 form a system 700.

List of reference symbols:

| | |
|---|---|
| 100, 101 | orbital welding device |
| 102 | hand-held device |
| 104 | welding head |
| 106 | receptacle |
| 108 | handle part |
| 110 | shaft |
| 112 | handle |
| 114 | connection for an exchangeable battery unit |
| 115 | connection for a protective gas unit |
| 116 | rechargeable battery unit |
| 120 | protective gas magazine |
| 122 | adjustment actuating element |
| 124 | electrode drive |
| 126 | welding electrode |
| 128 | welding current source |
| 130 | control unit |
| 132 | valve |
| 134 | user interface |
| 136 | display and operating elements |
| 138 | trigger |
| 140 | rechargeable battery |
| 142 | protective gas container |
| 150 | joining area |
| 152 | fitting |
| 154 | pipe end |
| 160 | fixed part |
| 162 | movable part |
| 164 | insertion opening |
| 166 | first opening |
| 168 | second opening |
| 170 | adjustment mechanism |
| 172 | electrode circulation mechanism |
| 174, 176 | outputs of the welding current source |
| 178 | contacting elements |
| 180 | axle |
| 182 | microprocessor |
| 184 | memory |
| 186, 188 | inputs |
| 190 | electronic circuit |
| 192 | welding current control |
| 194 | HV ignition |
| 200, 202 | contours |
| 210 | joining spot |
| 302 | electrode ring segment |
| 304 | ring segment opening |
| 306 | electrode holder |
| 308 | bevel gear wheel toothing |
| 310, 312 | drive bevel gear wheels |
| 311, 314, 315 | coupling bevel gear wheels |
| 320 | contacting means |
| 322 | contact ring segment |
| 324 | one side of the electrode ring segment |
| 326 | conductive ring segment |
| 328 | drive ring segment |
| 330 | pressing means |
| 332, 333 | pressing elements |
| 402, 403, 404, 405 | closure ring segment |
| 406 | ring segment opening |
| 410 | actuating element |
| 412 | gear |
| 414 | crown wheel |
| 416, 418 | gear wheel |
| 420 | outer toothing |
| 422, 424 | gear wheels |
| 426, 428 | intermediate gear wheels |
| 440 | upper cover |
| 442 | lower cover |
| 450 | welding head position sensor system |
| 452 | sensor |
| 700 | system |
| 710 | fitting opening |
| 714 | fitting outer contour |
| 750 | fitting fixing contour |

1. An orbital welding device,
with a welding head that has a receptacle for positioning a joining area of two joining partners, in particular a fitting and a pipe end, which joining partners are tubular at least in the joining area,
wherein
the welding head has a first opening and a second opening opposite the first opening, between which openings the receptacle extends, and
the welding head is adjustable between an open position and a closed position, wherein the welding head, in the open position, has an insertion opening connecting the first and second opening for inserting a joining area of two joining partners, which are tubular at least in the joining area, into the receptacle, and wherein the insertion opening is at least partially closed in the closed position.

2. The orbital welding device according to claim 1,
wherein
the welding head has one or more closure ring segments, each of which having a respective ring segment opening in the circumferential direction and being arranged in the circumferential direction around the receptacle and being mounted in such a way that the respective closure ring segment is rotatable about an imaginary longitudinal axis of the receptacle, and each of which, in the open position, being positioned in an open rotational position in which the respective ring segment opening forms part of the insertion opening, and, in the closed position, being positioned in a closed rotational position in which the respective closure ring segment at least partially closes the insertion opening.

3. The orbital welding device according to claim 1,
wherein the welding head has a plurality of closure ring segments and the direction of rotation from the open rotational position to the closed rotational position of at least two of the plurality of closure ring segments, in particular of two closure ring segments arranged next to each other in the longitudinal direction, is opposite.

4. The orbital welding device according to claim 1,
wherein one or more first ones of the one or more closure ring segments are arranged in the region of the first opening and/or one or more second ones of the one or more closure ring segments are arranged in the region of the second opening.

5. The orbital welding device according to claim 1,
wherein one or more upper ones of the one or more closure ring segments are connected in a rotationally fixed manner to an upper cover and/or one or more lower ones of the one or more closure ring segments are connected in a rotationally fixed manner to a lower cover, wherein the upper and/or lower cover clears the insertion opening in the open position of the welding head and at least partially close the insertion opening in the closed position of the welding head.

6. The orbital welding device according to claim 1,
wherein one, several or each of the closure ring segments is coupled to a gear, in particular a toothed gear, by means of which gear the respective closure ring segment are adjustable between the open rotational position and the closed rotational position.

7. The orbital welding device according to claim 1,
wherein an actuating element is provided, with which the one or more closure ring segments can be adjusted between the open rotational position and the closed rotational position.

8. The orbital welding device according to claim 1,
wherein the orbital welding device comprises a hand-held device which comprises the welding head and preferably a handle part connected to the welding head.

9. The orbital welding device according to claim 1,
wherein the orbital welding device comprises an electrode circulation mechanism and an electrode drive, in particular a motor, for driving the electrode circulation mechanism, wherein the electrode circulation mechanism is configured to move a welding electrode or an electrode holder therefor in the circumferential direction around the receptacle.

10. The orbital welding device according to claim 1,
the welding head has an electrode ring segment which is arranged in the circumferential direction around the receptacle and is mounted in such a way that the electrode ring segment can be rotated about an imaginary longitudinal axis of the receptacle,
the electrode ring segment has an electrode holder for a welding electrode and/or a welding electrode, and
the welding head has a plurality of driven drive wheels which are arranged such that, in each rotational position of the electrode ring segment about the imaginary longitudinal axis, at least one of the plurality of drive wheels is coupled to the electrode ring segment.

11. The orbital welding device according to claim 1,
wherein the orbital welding device comprises a welding current source which is electrically connected to the electrode ring segment, the welding electrode and/or the electrode holder therefor.

12. The orbital welding device according to claim 1,
wherein the orbital welding device comprises a control unit which is configured to control the orbital welding device in such a way that a weld seam consisting of a circumferential chain of joining spots is produced on two joining partners arranged in the receptacle.

13. The orbital welding device according to claim 1,
wherein the orbital welding device has a welding head position sensor system for detecting the open and/or closed position of the welding head.

14. A system
with an orbital welding device according to claim 1 and
with a fitting.

15. An orbital welding method, in particular carried out with an orbital welding device according to claim 1,
in which two joining partners, which are tubular at least in a joining area, are arranged relative to each other, in particular in a lapped joint, and
in which a chain of joining spots extending in the circumferential direction of the joining partners is produced in the joining area, which chain connects the joining partners in a material-locking manner.
